(19) United States
(12) Patent Application Publication
(10) Pub. No.: US 2019/0065994 A1
(43) Pub. Date: Feb. 28, 2019

(54) DEEP LEARNING-BASED IMAGE RECOGNITION METHOD AND APPARATUS

(71) Applicant: BOE TECHNOLOGY GROUP CO., LTD., Beijing (CN)

(72) Inventors: Lvwei Wang, Beijing (CN); Zhenglong Li, Beijing (CN)

(21) Appl. No.: 16/006,740

(22) Filed: Jun. 12, 2018

(30) Foreign Application Priority Data
Aug. 23, 2017 (CN) 201710730708.6

(51) Int. Cl. G06N 99/00; G06K 9/62; G06K 9/36

(52) U.S. Cl. CPC G06N 99/005; G06K 9/6256; G06K 9/6262; G06K 9/6253; G06K 9/36

(57) ABSTRACT

A deep learning-based image recognition method and apparatus are disclosed. The deep learning-based image recognition method comprises: training deep learning models based on deep learning frameworks, by using training image data, to obtain at least two deep learning models; selecting a predetermined number of deep learning models from the obtained deep learning models in a descending order of their recognition accuracies for verification image data, wherein the predetermined number is less than or equal to the number of the obtained deep learning models; and recognizing image data to be recognized using at least one of the selected deep learning models.

### CROSS-REFERENCE TO RELATED APPLICATION(S)

This application claims priority to the Chinese Patent Application No. 201710730708.6, filed on Aug. 23, 2017, entitled “METHOD, APPARATUS, AND COMPUTER DEVICE FOR DEVICE DEEP LEARNING-BASED IMAGE RECOGNITION” which is incorporated herein by reference in its entirety.

### TECHNICAL FIELD

The present disclosure relates to the field of deep learning technologies, and more particularly, to a deep learning-based image recognition method and a deep learning-based image recognition apparatus.

### BACKGROUND

The concept of deep learning stems from the research on artificial neural networks. Deep learning is a learning method based on characterization of data among machine learning methods. Observed values (such as an image) may be represented in various ways as a vector of intensity values of various pixels, or more abstractly, as a series of edges, an area having a particular shape, etc. The benefit of deep learning is to substitute manual acquisition of features with efficient unsupervised or semi-supervised algorithms for feature learning and hierarchical feature extraction.

Deep learning is a discipline which combines theory with practice. As new algorithm theories emerge, various deep learning frameworks continue to appear in people's field of vision. However, in the related art, functions which are provided by the deep learning frameworks are relatively simple and cause poor user experience.

### SUMMARY

In order to at least partially solve or alleviate one of the technical problems in the related art, there are proposed an image recognition method and apparatus, and a computer-readable storage medium according to the embodiments of the present disclosure.

According to an aspect of the present disclosure, there is proposed a deep learning-based image recognition method, comprising:

training deep learning models based on deep learning frameworks, by using training image data, to obtain at least two deep learning models;

selecting a predetermined number of deep learning models from the obtained deep learning models in a descending order of their recognition accuracies for verification image data, wherein the predetermined number is less than or equal to the number of the obtained deep learning models; and

recognizing image data to be recognized using at least one of the selected deep learning models.

According to another aspect of the present disclosure, there is proposed a deep learning-based image recognition apparatus, comprising:

a processor;

a memory having instructions stored thereon, which, when executed by the processor, cause the processor to:

train deep learning models based on deep learning frameworks by using training image data to obtain at least two deep learning models;

select a predetermined number of deep learning models from the obtained deep learning models in a descending order of their recognition accuracies for verification image data, wherein the predetermined number is less than or equal to the number of the obtained deep learning models; and

recognize image data to be recognized using at least one of the selected deep learning models.

According to yet another aspect of the present disclosure, there is proposed a non-transitory computer-readable storage medium having computer programs stored thereon, which, when executed by a processor, cause the processor to perform the method described above.

According to other aspects of the present disclosure, there is proposed a computer program product, wherein instructions in the computer program products, which, when executed by a processor, cause the processor to perform the method described above.

Additional aspects and advantages of the present disclosure will be set forth in part in the description which follows, or in part will be obvious from the description which follows, or may be learned by practice of the embodiments of the present disclosure.

### BRIEF DESCRIPTION OF THE DRAWINGS

The above and/or additional aspects and advantages of the present disclosure will become apparent and easily understood from the following description of embodiments in conjunction with the accompanying drawings, in which:

FIG. 1 is an exemplary flowchart of a deep learning-based image recognition method according to an embodiment of the present disclosure;

FIG. 2 is an exemplary flowchart of a deep learning-based image recognition method according to another embodiment of the present disclosure;

FIG. 3 is an exemplary flowchart of a deep learning-based image recognition method according to yet another embodiment of the present disclosure;

FIG. 4 is an exemplary flowchart of a deep learning-based image recognition method according to yet another embodiment of the present disclosure;

FIG. 5 is an exemplary structural diagram of a deep learning-based image recognition apparatus according to an embodiment of the present disclosure;

FIG. 6 is an exemplary structural diagram of a deep learning-based image recognition apparatus according to another embodiment of the present disclosure; and

FIG. 7 is an exemplary structural diagram of a computer device according to an embodiment of the present disclosure.

### DETAILED DESCRIPTION

Some of the embodiments of the present disclosure will be described in detail below. Examples of the embodiments are illustrated in the accompanying drawings, throughout which the same or similar reference signs denote the same or similar elements or elements having the same or similar functions. The embodiments described below with reference to the accompanying drawings are exemplary and are intended to explain the present disclosure, but should not be construed as limiting the present disclosure.

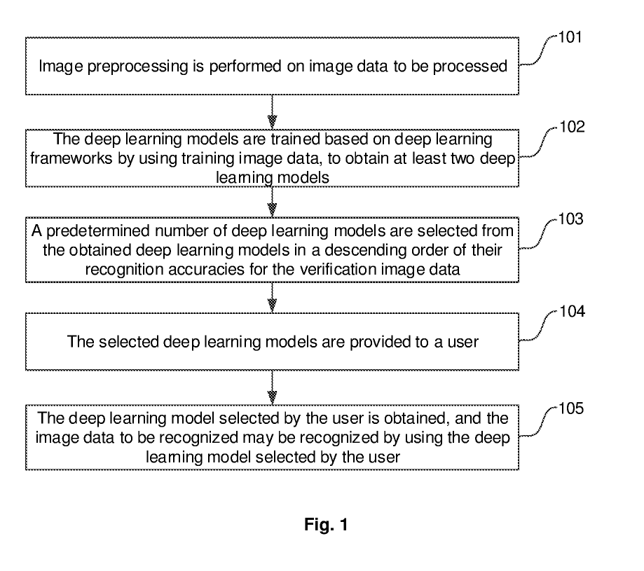

FIG. 1 is an exemplary flowchart of a deep learning-based image recognition method according to an embodiment of the present disclosure. As shown in FIG. 1, the deep learning-based image recognition method may comprise the following steps.

In an optional step 101, image preprocessing is performed on image data to be processed. In some embodiments, the image data to be processed may comprise one or more of training image data for training deep learning models based on deep learning frameworks, verification image data for verifying the trained deep learning models, and/or image data to be recognized. However, it should be illustrated that the image preprocessing process is not necessary in this method. In other words, the method can directly process an original image or process image data processed by a third party. Regardless, this image preprocessing step is optional.

In step 102, the deep learning models are trained based on deep learning frameworks by using training image data, to obtain at least two deep learning models. In some embodiments, the number of the deep learning frameworks may be equal to or greater than two.

In the present embodiment, the deep learning frameworks may be PyTorch, Tensorflow, Caffe, Keras, MXNet, etc., which is not limited in the present embodiment. At least two deep learning models may be obtained by training the deep learning models based on the deep learning frameworks by using the training image data. For example, different deep learning models may be obtained by setting different initial parameters and using the same training image data. Alternatively, a plurality of different deep learning models may be obtained by training deep learning models based on different deep learning frameworks using the same training image data, by training deep learning models having different activation functions using the same training image data, or by training the same or different deep learning models using different training image data etc. These different deep learning models may reflect features learned by corresponding deep learning frameworks from corresponding training image data under corresponding initial parameter settings, so that the deep learning models may have possibly different recognition accuracy for the same verification image data.

In step 103, a predetermined number of deep learning models are selected from the obtained deep learning models in a descending order of their recognition accuracies for the verification image data.

The predetermined number may be less than or equal to the number of the obtained deep learning models, and the predetermined number may be set according to system performance and/or implementation requirements, etc. in a specific implementation, and is not limited in the present embodiment. For example, the predetermined number may be 2.

In the present embodiment, after a plurality of deep learning models are obtained through training, it often needs to verify the recognition accuracy of the learned deep learning models for a verification set or verification image data. Therefore, in the present embodiment, according to the recognition accuracy of each of the deep learning models obtained through training for the verification image data, a predetermined number of deep learning models are selected in a descending order of their recognition accuracies. For example, when the predetermined number is 2, deep learning models with the highest accuracy and the second highest accuracy may be selected from the deep learning models obtained through training according to their recognition accuracies of the deep learning models obtained through training for the verification set.

In an optional step 104, the selected deep learning models may be provided to a user.

In the present embodiment, after a predetermined number of deep learning models are selected from the deep learning models obtained through training in a descending order of their recognition accuracies for the verification set, the selected deep learning models may be provided to the user.

In a specific implementation, after the predetermined number of deep learning models are selected in the descending order of their recognition accuracies for the verification set, the selected deep learning models may be stored, and then the stored deep learning models may be provided to the user so that the user may select deep learning models for use. For example, a plurality of options and corresponding descriptions may be provided in a user interface displayed on a display so that the user may select options for use.

In an optional step 105, the deep learning model selected by the user is obtained, and the image data to be recognized may be recognized by using the deep learning model selected by the user.

In the present embodiment, after new image data is received, the deep learning models to be used may be determined according to, for example, options which may be selected by the user on the user interface, and the image data to be recognized may be recognized using the deep learning models.

More generally, after the predetermined number of deep learning models are selected from the obtained deep learning models in the descending order of their recognition accuracies for the verification image data, the image data to be recognized may be recognized using at least one of the selected deep learning models. For example, the at least one deep learning model may not be manually selected by the user, but may be automatically selected by a computer, a server, etc. (for example, a deep learning model with the highest accuracy, a deep learning model with the fastest training convergence speed, a deep learning model with the fastest recognition speed, or a deep learning model which satisfies other conditions is recognized from these deep learning models.) In other words, this step may be fully automated, without participation of human users.

In the deep learning-based image recognition method, after image preprocessing is performed on image data to be processed, the deep learning models may be trained based on deep learning frameworks by using training image data to obtain at least two deep learning models, then a predetermined number of deep leaning models are selected from the deep learning models obtained through training in a descending order of their recognition accuracies for a verification set, the selected deep learning models are provided to a user, the deep learning model selected by the user is obtained, and image data to be recognized is recognized by using the deep learning model selected by the user. In this way, an overall solution for providing a deep learning framework can be realized, which is convenient for users to obtain deep learning models, and then recognize received image data through the obtained deep learning models, thereby improving the accuracy of image recognition and enhancing the user experience. In some embodiments, the number of the deep learning frameworks may be equal to or greater than two.

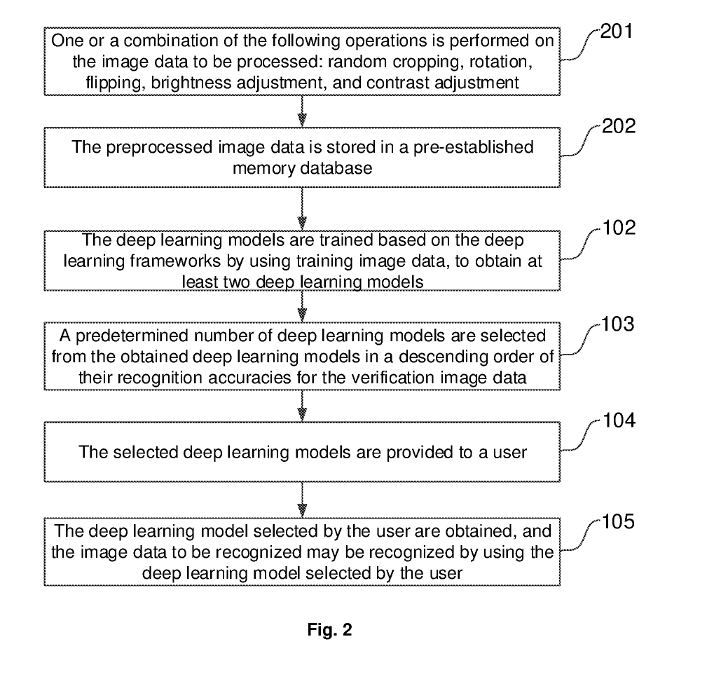

FIG. 2 is an exemplary flowchart of a deep learning-based image recognition method according to another embodiment of the present disclosure. As shown in FIG. 2, step 101 of the embodiment shown in FIG. 1 of the present disclosure may comprise the following step.

In step 201, one or a combination of the following operations is performed on the image data to be processed: random cropping, rotation, flipping, brightness adjustment, and contrast adjustment.

In the present embodiment, before the image data is trained, it needs to firstly perform image preprocessing on the image data to be processed, which comprises performing operations such as random cropping, rotation, flipping, brightness adjustment, and/or contrast adjustment etc. on the image data to be processed.

Further, after step 201, the method may further comprise the following step.

In step 202, the preprocessed image data is stored in a pre-established memory database.

In the present embodiment, the pre-established memory database may be a deep learning database, such as a Lightning Memory-Mapped Database (LMDB for short hereinafter) or a LevelDB etc. Of course, other types of databases may also be used as the above memory database. A specific type of the memory database which is used is not limited in the present embodiment.

After image preprocessing is performed on the image data to be processed, the processed image data may be stored in a pre-established memory database.

In the present embodiment, after image preprocessing is performed on the image data to be processed, step 102 may be directly performed, or step 202 may be performed firstly, and then step 102 is performed, in which case, in step 102, the deep learning models may be trained based on deep learning frameworks by using the training image data stored in the memory database, so as to obtain deep learning models. In some embodiments, the number of the deep learning frameworks may be equal to or greater than two.

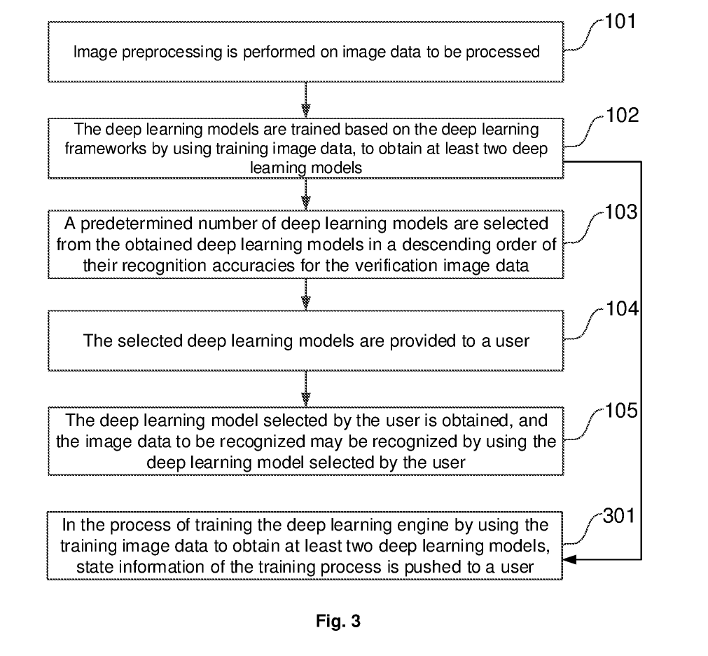

FIG. 3 is an exemplary flowchart of a deep learning-based image recognition method according to yet another embodiment of the present disclosure. As shown in FIG. 3, after step 102 of the embodiment shown in FIG. 1 of the present disclosure, the method may further comprise the following step.

In step 301, in the process of training the deep learning models based on deep learning frameworks using the training image data to obtain at least two deep learning models, state information for the training process is pushed to a user.

In the present embodiment, in order to facilitate the user to focus on the training process, in the process of training the deep learning models based on deep learning frameworks using the training image data to obtain deep learning models, the state information for the training process such as error, Information (Info) or warning etc. may be pushed in real time to an account of instant messaging software which is registered by the user, such as WeChat or QQ etc.

Of course, the state information for the training process may also be pushed in real time to an account of email which is registered by the user, or the state information for the training process may also be transmitted to a mobile phone of the user through a short message. A manner of pushing the state information for the training process is not limited in the present embodiment, as long as the state information for the training process can be pushed to the user.

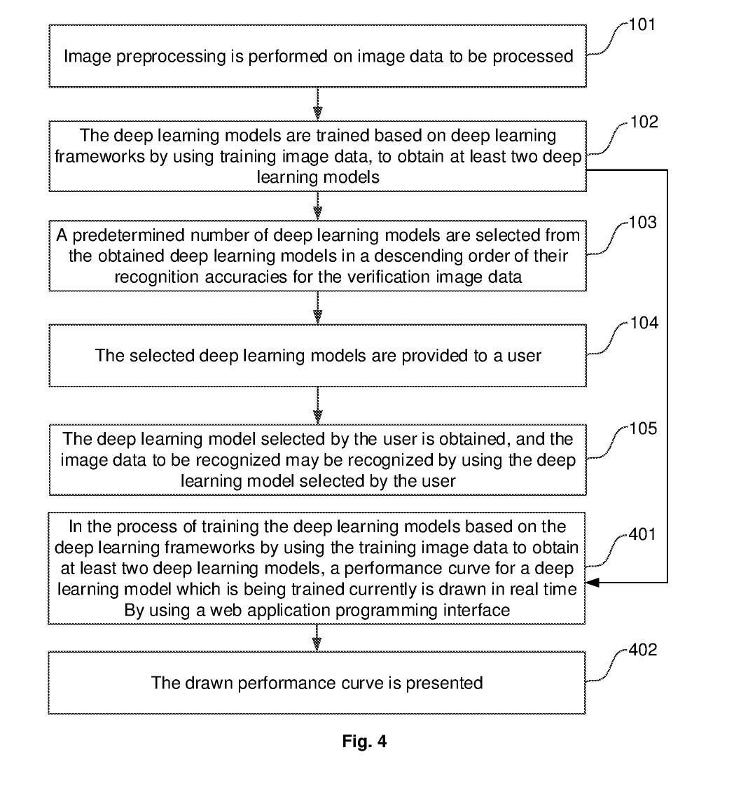

FIG. 4 is an exemplary flowchart of a deep learning-based image recognition method according to yet another embodiment of the present disclosure. As shown in FIG. 4, after step 102 of the embodiment shown in FIG. 1 of the present disclosure, the method may further comprise the following steps.

In step 401, in the process of training the deep learning models based on deep learning frameworks using the training image data to obtain at least two deep learning models, a performance curve for a deep learning model which is being trained currently is drawn in real time using a web Application Programming Interface (API for short hereinafter).

In step 402, the drawn performance curve is presented.

In the present embodiment, in the process of training the deep learning models based on deep learning frameworks by using the training image data to obtain deep learning models, performance curves such as a training loss, training accuracy, and/or a confusion matrix etc. of the deep learning model which is trained currently may be drawn in real time by using a web API (for example, Crayon or Tensorboard etc.) and are presented to the user.

The deep learning-based image recognition method according to some embodiments of the present disclosure provides an overall solution of a deep learning framework, which is convenient for the user to obtain deep learning models, and then can realize recognition of the received image data through the obtained deep learning models, thereby improving the accuracy of image recognition and enhancing the user experience.

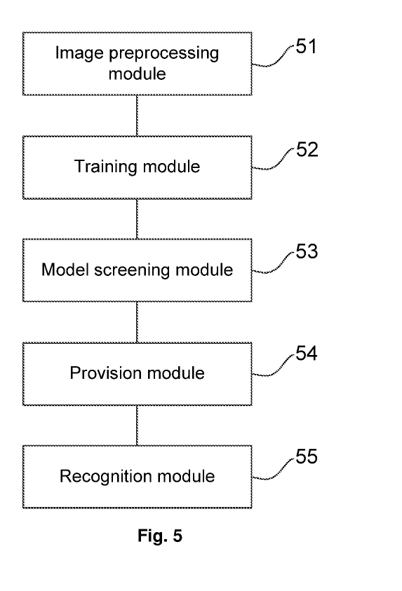

FIG. 5 is an exemplary structural diagram of a deep learning-based image recognition apparatus according to an embodiment of the present disclosure. The deep learning-based image recognition apparatus in the present embodiment may perform the deep learning-based image recognition method according to the embodiments of the present disclosure. As shown in FIG. 5, the deep learning-based image recognition apparatus may comprise an optional image preprocessing module 51, a training module 52, a model screening module 53, an optional provision module 54, and a recognition module 55.

The optional image preprocessing module 51 is configured to perform image preprocessing on image data to be processed.

The training module 52 is configured to train deep learning models based on deep learning frameworks using training image data to obtain at least two deep learning models. In the present embodiment, the deep learning frameworks may be PyTorch, Tensorflow, Caffe, Keras, MXNet, etc., which is not limited in the present embodiment. The training module 52 trains the deep learning models based on the deep learning frameworks by using the training image data, which may obtain at least two deep learning models.

The model screening module 53 is configured to select a predetermined number of deep learning models from the deep learning models obtained by the training module 52 in a descending order of their recognition accuracies for verification image data; wherein the predetermined number is less than or equal to the number of the obtained deep learning models. The predetermined number may be set according to system performance and/or implementation requirements, etc. in a specific implementation, and is not limited in the present embodiment. For example, the predetermined number may be 2.

In the present embodiment, after the training module 52 performs training to obtain the deep learning models, it needs to verify the recognition accuracy of the deep learning models for a verification set. Therefore, in the present embodiment, the model screening module 53 selects a predetermined number of deep learning models in the descending order of their recognition accuracies of the deep learning models obtained through training for the verification set. For example, when the predetermined number is 2, the model screening module 53 may select deep learning models with the highest recognition accuracy and the second highest recognition accuracy from the deep learning models obtained through training according to their recognition accuracies of the deep learning models obtained through training for the verification set.

The optional provision module 54 is configured to provide the deep learning models selected by the model screening module 53 to a user. In the present embodiment, after the model screening module 53 selects a predetermined number of deep learning models from the deep learning models obtained through training in the descending order of their recognition accuracies for the verification set, the provision module 54 may provide the selected learning models to the user.

In a specific implementation, after the model screening module 53 selects a predetermined number of deep learning models in the descending order of their recognition accuracies for the verification set, the model screening module 53 may store the selected deep learning models, and then the providing model 54 may provide the deep learning models stored by the model screening model 53 to the user, so that the user may select deep learning models for use.

The optional recognition module 55 is configured to obtain the deep learning model selected by the user, and recognize image data to be recognized through the deep learning model selected by the user.

In the present embodiment, after new image data is received, the recognition module 55 may obtain the deep learning model selected by the user, and realize recognition of the received image data through the deep learning model selected by the user.

As described above, more generally, the recognition module 55 may recognize the image data to be recognized using at least one of the selected deep learning models without participation of users after the predetermined number of deep learning models are selected from the obtained deep learning models in the descending order of their recognition accuracies for the verification image data. For example, the at least one deep learning model may not be manually selected by the user, but may be automatically selected by a computer, a server, etc. (for example, a deep learning model with the highest accuracy, a deep learning model with the fastest training convergence speed, a deep learning model with the fastest recognition speed, or a deep learning model which satisfies other conditions is recognized from these deep learning models.)

In the deep learning-based image recognition apparatus, after the optional image preprocessing module 51 performs image preprocessing on the image data to be processed, the training module 52 trains deep learning models based on deep learning frameworks by using training image data to obtain at least two deep learning models, then the model screening module 53 selects a predetermined number of deep leaning models from the deep learning models obtained through training in a descending order of their recognition accuracies for a verification set, the optional provision module 54 provides the selected deep learning models to a user, and the optional recognition module 55 may obtain the deep learning model selected by the user, and recognize received image data by using the deep learning model selected by the user. In this way, an overall solution for providing a deep learning framework can be realized, which is convenient for users to obtain deep learning models, and then realize recognition of the received image data through the obtained deep learning models, thereby improving the accuracy of image recognition and enhancing the user experience.

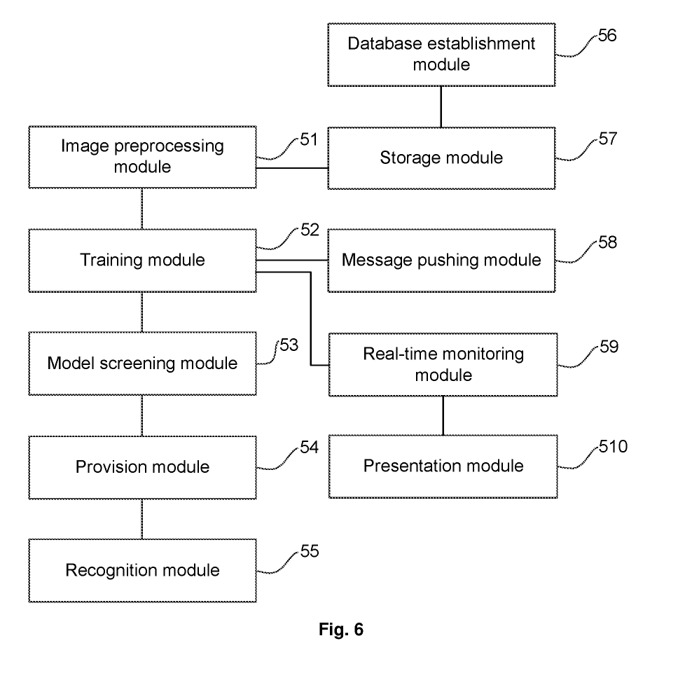

FIG. 6 is an exemplary structural diagram of a deep learning-based image recognition apparatus according to another embodiment of the present disclosure. The deep learning-based image recognition apparatus shown in FIG. 6 differs from the deep learning-based image recognition apparatus shown in FIG. 5 in that the image preprocessing module 51 may be specifically configured to perform one or a combination of the following operations on the image data to be processed: random cropping, rotation, flipping, brightness adjustment, and contrast adjustment.

In the present embodiment, before the training module 52 trains the image data, the image preprocessing module 51 needs to firstly perform image preprocessing on the image data to be processed, which comprises performing operations such as random cropping, rotation, flipping, brightness adjustment, and/or contrast adjustment etc. on the image data to be processed.

Further, the deep learning-based image recognition apparatus may further comprise: a database establishment module 56 and a storage module 57; wherein

the database establishment module 56 is configured to establish a memory database; and

the storage module 57 is configured to store the processed image data in the memory database which is pre-established by the database establishment module 56 after the image preprocessing module 51 performs image preprocessing on the image data to be processed.

In the present embodiment, the memory database which is pre-established by the data establishment module 56 may be a deep learning database, such as an LMDB or a LevelDB etc. Of course, other types of databases may also be used as the above memory database. A specific type of the memory database which is used is not limited in the present embodiment.

After the image preprocessing module 51 performs image preprocessing on the image data to be processed, the storage module 57 may store the processed image data in the memory database which is pre-established by the database establishment module 56.

Further, the deep learning-based image recognition apparatus may further comprise a message pushing module 58; wherein

the message pushing module 58 is configured to, in the process of training the deep learning models based on deep learning frameworks using the training image data to obtain deep learning models, push state information for the training process to a user.

In the present embodiment, in order to facilitate the user to focus on the training process, in the process of training the deep learning models based on deep learning frameworks using the training image data to obtain deep learning models, the message pushing module 58 may push the state information for the training process such as error, Information (Info) or warning etc. in real time to an account of instant messaging software which is registered by the user, such as WeChat or QQ etc.

Of course, the message pushing module 58 may also push the state information for the training process in real time to an account of email which is registered by the user, or the message pushing module 58 may also transmit the state information for the training process to a mobile phone of the user through a short message. A manner of pushing the state information for the training process by the message pushing module 58 is not limited in the present embodiment, as long as the state information for the training process can be pushed to the user.

Further, the deep learning-based image recognition apparatus may further comprise a real-time monitoring module 59 and a presentation module 510, wherein

the real-time monitoring module 59 is configured to, in the process of training the deep learning models based on deep learning frameworks by the training module 52 using the training image data to obtain deep learning models, draw a performance curve for a deep learning model which is being trained currently in real time by using a web API; and

the presentation module 510 is configured to present the performance curve drawn by the real-time monitoring module 59.

In the present embodiment, in the process of training the deep learning models based on deep learning frameworks by using the training image data to obtain deep learning models, performance curves such as a training loss, training accuracy, and/or a confusion matrix etc. of a deep learning model which is being trained currently may be drawn by the real-time monitoring module 59 in real time by using a web API (for example, Crayon or Tensorboard etc.) and are presented to the user.

The deep learning-based image recognition apparatus according to some embodiments of the present disclosure provides an overall solution of a deep learning framework, which is convenient for the user to obtain deep learning models, and then can realize recognition of the received image data through the obtained deep learning models, thereby improving the accuracy of image recognition and enhancing the user experience.

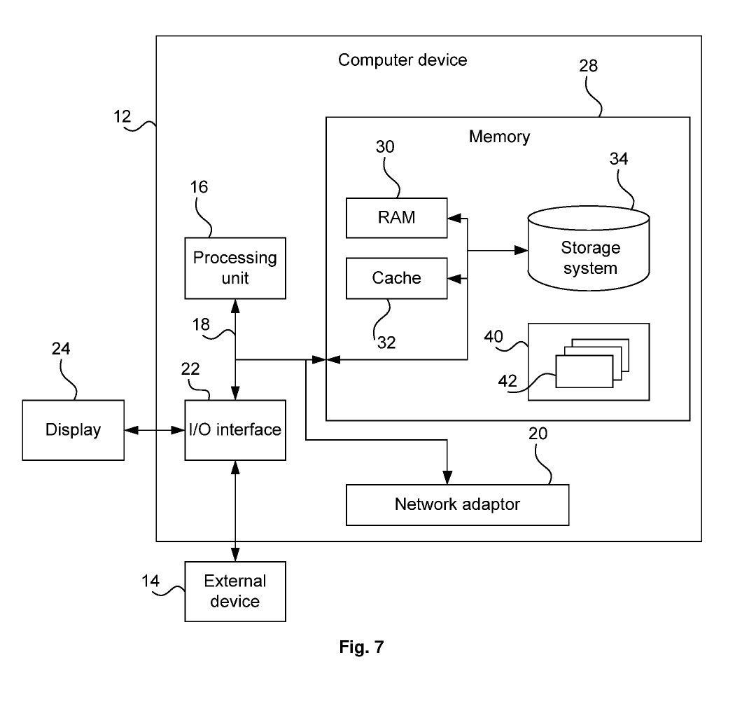

FIG. 7 is a structural diagram of a database of a computer device according to an embodiment of the present disclosure. The computer device may comprise a memory, a processor, and computer programs which are stored on the memory and are executable on the processor. The computer programs, when executed by the processor, can perform the deep learning-based image recognition method according to some embodiments of the present disclosure.

The computer device may be a terminal device or a server. A specific form of the computer device is not limited in the present embodiment.

FIG. 7 illustrates a block diagram of an exemplary computer device 12 suitable for implementing some embodiments of the present disclosure. The computer device 12 shown in FIG. 7 is merely an example and should not impose any limitation on functions and a usage scope of the embodiments of the present disclosure.

As shown in FIG. 7, the computer device 12 is implemented in a form of a general-purpose computing device. Components of the computer device 12 may include, but not limited to, one or more processors or processing units 16, a system memory 28, a bus 18 for connecting different system components (including the system memory 28 and the processing unit 16.)

The bus 18 represents one or more of several types of bus structures, including a memory bus or memory controller, a peripheral bus, a graphics acceleration port, a processor, or a local bus using any of a variety of bus structures. For example, these architectures include, but not limited to, an Industry Standard Architecture (ISA for short hereinafter) bus, a Micro Channel Architecture (MAC for short hereinafter) bus, an enhanced ISA bus, a Video Electronics Standards Association (VESA for short hereinafter) local bus and a Peripheral Component Interconnect (PCI for short hereinafter) bus.

The computer device 12 typically comprises a variety of computer system readable media. These media may be any available media which can be accessed by the computer device 12, including volatile and non-volatile media, and removable and non-removable media.

The system memory 28 may comprise computer system readable media in a form of volatile memory, such as a Random Access Memory (RAM for short hereinafter) 30 and/or a cache memory 32. The computer device 12 may further comprise other removable/non-removable, and volatile/non-volatile computer system storage media. By way of example only, a storage system 34 may be used to read from and write into non-removable and non-volatile magnetic media (not shown in FIG. 7, commonly referred to as “hard drivers”.) Although not shown in FIG. 7, a magnetic disk driver for reading from and writing into a removable and non-volatile magnetic disk (for example, a “floppy disk”) and an optical disk driver for reading from and writing into a removable and non-volatile optical disk (for example, a Compact Disc Read Only Memory (CD-ROM for short hereinafter), a Digital Video Disc Read Only Memory (DVD-ROM for short hereinafter), or other optical media.) In these cases, each driver may be connected to the bus 18 via one or more data medium interfaces. The memory 28 may comprise at least one program product having a group of (for example, at least one) program modules which are configured to perform the functions of various embodiments of the present disclosure.

A program/utility 40 having a group of (at least one) program modules 42 may be stored in the memory 28, for example. Such program modules 42 include, but not limited to, an operating system, one or more applications, other program modules and program data, and each or some combination of these examples may include implementations of a network environment. The program modules 42 generally perform the functions and/or methods described in the embodiments of the present disclosure.

The computer device 12 may also communicate with one or more external devices 14 (for example, a keyboard, a pointing device, a display 24, etc.), may also communicate with one or more devices which enable a user to interact with the computer device 12, and/or any device (for example, a network card, a modem etc.) which enables the computer device 12 to communicate with one or more other computing devices. This communication may be performed through an Input/Output (I/O) interface 22. Moreover, the computer device 12 may also communicate with one or more networks (for example, a Local Area Network (LAN for short hereinafter), a Wide Area Network (WAN for short hereinafter) and/or a public network (for example, the Internet) through a network adapter 20. As shown in FIG. 7, the network adapter 20 communicates with other modules of the computer device 12 via the bus 18. It should be appreciated that, although not shown in FIG. 7, other hardware and/or software modules may be used in conjunction with the computer device 12, including, but not limited to: a microcode, a device driver, a redundant processing unit, an external magnetic disk driving array, a RAID system, a tape driver and a data backup storage system etc.

The processing unit 16 executes various kinds of functional applications and data processing by executing a program stored in the system memory 28, for example, a deep learning-based image recognition method according to the embodiments of the present disclosure.

The embodiments of the present disclosure further provide a non-transitory computer-readable storage medium on which computer programs are stored. The computer programs, when executed by a processor, can perform the deep learning-based image recognition method according to the embodiments of the present disclosure.

The non-transitory computer-readable storage media may employ any combination of one or more computer-readable media. The computer-readable media may be computer-readable signal media or computer-readable storage media. The computer-readable storage media may be, for example but not limited to, an electronic, magnetic, optical, electromagnetic, infrared, or semiconductor system, apparatus, or device, or any combination thereof. More specific examples (non-exhaustive listings) of the computer-readable storage media include electrical connections with one or more wires, a portable computer magnetic disk, a hard disk, a Random Access Memory (RAM), a Read Only Memory (ROM for short hereinafter), an Erasable Programmable Read Only Memory (EPROM for short hereinafter) or a flash memory, an optical fiber, a portable Compact Disc-Read Only Memory (CD-ROM), an optical storage device, a magnetic memory device, or any suitable combination thereof. The computer readable storage media herein may be any tangible medium which may contain or store a program for use by or in connection with an instruction execution system, apparatus, or device.

The computer readable signal media may include a data signal which propagates in baseband or as a part of a carrier wave, wherein the data signal carries computer readable program codes. The propagated data signal may take a variety of forms including, but not limited to, an electromagnetic signal, an optical signal, or any suitable combination thereof. The computer-readable signal medium may also be any computer-readable medium other than a computer-readable storage medium, which may send, propagate, or transmit programs for use by or in connection with an instruction execution system, apparatus, or device.

The program codes embodied on the computer readable medium may be transmitted using any appropriate medium, including, but not limited to, radio, wire, fiber optic cable, RF, etc., or any suitable combination thereof.

The computer program codes for carrying out operations according to embodiments of the present disclosure may be written using one or more programming languages, or a combination thereof, including object-oriented programming languages such as Java, Smalltalk, C++, and also including conventional procedural programming languages such as the “C” language or similar programming languages. The program codes may be executed entirely on a user computer, may be executed partly on the user computer, may be executed as a stand-alone software package, may be executed partly on the user computer and partly on a remote computer, or may be executed entirely on the remote computer or a server. In a case of the remote computer, the remote computer may be connected to the user computer through any kind of network including a Local Area Network (LAN for short hereinafter) or a Wide Area Network (WAN for short hereinafter), or may be connected to an external computer (for example, using an Internet service provider via the Internet).

The embodiments of the present disclosure provide a computer program product. Instructions in the computer program product, when executed by a processor, may execute the deep learning-based image recognition method according to the embodiments of the present disclosure.

In the description of the present specification, the description referring to the terms “one embodiment”, “some embodiments”, “an example”, “a specific example”, or “some examples” etc. means that a specific feature, structure, material or characteristics described in conjunction with the embodiment or example is included in at least one embodiment or example of the present disclosure. In the present specification, schematic expressions of the above terms do not necessarily have to refer to the same embodiment or example. Furthermore, the specific feature, structure, material, or characteristics described may be combined in any suitable manner in any one or more embodiments or examples. In addition, those skilled in the art can combine and merge different embodiments or examples described in the present specification and features in different embodiments or examples without conflicting with each other.

Furthermore, the terms “first” and “second” are used for descriptive purposes only, and are not to be construed as indicating or implying relative importance or implicitly indicating a number of indicated technical features. Thus, features defined by “first” and “second” may explicitly or implicitly indicate that least one of the features is included. In the description of the embodiments of the present disclosure, “plurality” means at least two, such as two, three, etc., unless explicitly and specifically defined otherwise.

Any process or method described in the flowcharts or described elsewhere herein may be construed as meaning modules, sections, or portions including codes of executable instructions of one or more steps for implementing a custom logic function or process. Further, the scope of the preferred implementations of the embodiments of the present disclosure includes additional implementations in which functions may be performed in a substantially simultaneous manner or in a reverse order, depending on the functions involved, instead of the order shown or discussed, which should be understood by those skilled in the art to which the embodiments of the present disclosure pertain.

A logic and/or steps represented in the flowcharts or otherwise described herein, for example, may be considered as a sequence listing of executable instructions for implementing logical functions, and may be embodied in any computer-readable medium for use by an instruction execution system, apparatus or device (for example, a computer-based system, a system including a processor or other systems which may obtain instructions from the instruction execution system, apparatus or device and may execute the instructions), or may be used in combination with the instruction execution system, apparatus or device. As for this specification, a “computer-readable medium” may be any means which may contain, store, communicate, propagate, or transmit programs for use by or in connection with the instruction execution system, apparatus, or device. More specific examples (non-exhaustive listings) of the computer-readable media include an electrical connection part (an electronic apparatus) having one or more wirings, a portable computer disk cartridge (a magnetic apparatus), a Random Access Memory (RAM for short hereinafter), a Read Only Memory (ROM for short hereinafter), an Erasable and Programmable Read Only Memory (an EPROM for short hereinafter) or a flash memory, a fiber optic apparatus, and a portable Compact Disc-Read Only Memory (CD-ROM for short hereinafter). In addition, the computer-readable media may even be paper or other suitable medium on which the programs may be printed, as the programs may be obtained electronically by optically scanning the paper or the other medium and then editing, interpreting, or performing other suitable processing (if necessary) on the paper or the other medium, and then the programs are stored in a computer memory.

It should be understood that portions of the embodiments of the present disclosure may be implemented in hardware, software, firmware, or a combination thereof. In the above embodiments, a plurality of steps or methods may be implemented using software or firmware stored in a memory and executed by a suitable instruction execution system. For example, if implemented in hardware, as in another embodiment, it can be implemented using any one or a combination of the following techniques known in the art: discrete logic gates having logic gate circuits for implementing logic functions on data signals, an application-specific integrated circuit having a suitable combinational logic gate circuit, a Programmable Gate Array (PGA for short hereinafter), a Field Programmable Gate Array (FPGA for short hereinafter), etc.

It can be understood by those of ordinary skill in the art that all or a part of steps carried in the method according to the embodiments may be completed by programs instructing a related hardware. The programs may be stored in a computer-readable storage medium. When executed, the programs include one or a combination of the steps of the method embodiments.

In addition, various functional units in various embodiments of the present disclosure may be integrated in one processing module, or may exist alone physically, or two or more units may be integrated in one module. The integrated module may be implemented in a form of hardware or in a form of a software functional module. The integrated module may also be stored in a computer readable storage medium if it is implemented in a form of a software functional module and sold or used as an independent product.

The above-mentioned storage medium may be a read-only memory, a magnetic disk or an optical disk, etc. Although the embodiments of the present disclosure have been shown and described above, it can be understood that the above embodiments are exemplary and are not to be construed as limiting the present disclosure, and those of ordinary skill in the art can make changes, modifications, substitutions and variations to the above embodiments within the scope of the present disclosure.

I/We claim:

1. A deep learning-based image recognition method, comprising:
training deep learning models based on deep learning frameworks by using training image data, to obtain at least two deep learning models;
selecting a predetermined number of deep learning models from the obtained deep learning models in a descending order of their recognition accuracies for verification image data, wherein the predetermined number is less than or equal to a number of the obtained deep learning models; and
recognizing image data to be recognized using at least one of the selected deep learning models.

2. The method according to claim 1, further comprising:
performing image preprocessing on at least one of the training image data, the verification image data, and the image data to be recognized.

3. The method according to claim 2, wherein the image preprocessing comprises at least one of:
random cropping, rotation, flipping, brightness adjustment, and contrast adjustment.

4. The method according to claim 3, further comprising:
storing preprocessed image data in a pre-established memory database.

5. The method according to claim 1, wherein recognizing image data to be recognized using at least one of the selected deep learning models comprises:
providing the selected deep learning models to a user; and
obtaining a deep learning model selected by the user, and recognizing the image data to be recognized by using the deep learning model selected by the user.

6. The method according to claim 1, wherein training deep learning models based on deep learning frameworks by using training image data to obtain at least two deep learning models comprises:
pushing state information for the training process to a user.

7. The method according to claim 1, wherein training deep learning models based on deep learning frameworks by using training image data to obtain at least two deep learning models comprises drawing, in real time, a performance curve for a deep learning model which is being trained currently by using a web application programming interface; and the method further comprises:
presenting the drawn performance curve.

8. The method according to claim 1, wherein a number of the deep learning frameworks is equal to or greater than two.

9. A deep learning-based image recognition apparatus, comprising:
a processor; and
a memory having instructions stored thereon, which, when executed by the processor, cause the processor to:
train deep learning models based on deep learning frameworks, by using training image data, to obtain at least two deep learning models;
select a predetermined number of deep learning models from the obtained deep learning models in a descending order of their recognition accuracies for verification image data, wherein the predetermined number is less than or equal to a number of the obtained deep learning models; and
recognize image data to be recognized using at least one of the selected deep learning models.

10. The apparatus according to claim 9, wherein the instructions, when executed by the processor, further cause the processor to:
perform image preprocessing on at least one of the training image data, the verification image data, and the image data to be recognized.

11. The apparatus according to claim 10, wherein the image preprocessing comprises at least one of:
random cropping, rotation, flipping, brightness adjustment, and contrast adjustment.

12. The apparatus according to claim 9, wherein the instructions, when executed by the processor, further cause the processor to:
establish a memory database; and
store preprocessed image data in the pre-established memory database.

13. The apparatus according to claim 9, wherein the instructions, when executed by the processor, further cause the processor to:
provide the selected deep training models to a user; and
obtain a deep learning model selected by the user, and recognize the image data to be recognized by using the deep learning model selected by the user.

14. The apparatus according to claim 9, wherein the instructions, when executed by the processor, further cause the processor to:
in the process of training deep learning models based on deep learning frameworks by using training image data to obtain at least two deep learning models, push state information for the training process to a user.

15. The apparatus according to claim 9, wherein the instructions, when executed by the processor, further cause the processor to:
in the process of training deep learning models based on deep learning frameworks by using training image data to obtain at least two deep learning models, draw, in real time, a performance curve for a deep learning model which is being trained currently by using a web application programming interface; and
present the drawn performance curve.

16. The apparatus according to claim 9, wherein a number of the deep learning frameworks is equal to or greater than two.

17. A non-transitory computer-readable storage medium having computer programs stored thereon, which, when executed by a processor, cause the processor to perform the method according to claim 1.
